(19) United States
(12) Patent Application Publication
(10) Pub. No.: US 2002/0070235 A1
(43) Pub. Date: Jun. 13, 2002

(54) Sugar dispensing system

(76) Inventor: Johnny Dean Childers, Crown Point, IN (US)

Correspondence Address: Richard W. Goldstein, 2071 Clove Road, Staten Island, NY, 10304, US

(21) Appl. No.: 09/735,350

(22) Filed: Dec. 13, 2000

(51) Int. Cl. G01F 11/10; B67D 5/64

(52) U.S. Cl. 222/132; 222/156; 222/361

(57) ABSTRACT

A sugar dispensing system including a housing having a top wall, a bottom wall, a front wall, a rear wall, and opposed side walls. The top wall has an opening therein exposing a general storage chamber. The general storage chamber has a closed bottom wall. The closed bottom wall has a plurality of openings disposed therein. The front wall has a recess formed therein upwardly of the bottom wall. A plurality of storage vials are disposed within the housing. The storage vials each have open upper and lower ends. The open upper ends are aligned with the plurality of openings in the closed bottom wall of the general storage chamber. The open lower ends are exposed above the recess in the front wall of the housing. The storage vials include dispensing mechanisms at the open lower ends thereof.

### BACKGROUND OF THE INVENTION

The present invention relates to a sugar dispensing system and more particularly pertains to allowing pre-measured amounts of sugar to be accurately dispensed into an awaiting vessel.

People use sugar and other spices for numerous applications. When using sugar and spices for recipes, one often has to use measuring spoons and the like in order to properly add the required amounts of the spices called for in the recipe. This is typically a time consuming task that people often make mistakes by putting the improper measurements of spices into a mixture. What is needed is a more effective and quicker way of measuring and dispensing sugar and other spices when needed for recipes or other needs, such as simply adding a desired amount of sugar into an awaiting cup of coffee.

The present invention attempts to solve the above-mentioned problem by providing a system that will hold pre-measured quantities of sugar, or other spices, that can easily be dispensed for whatever use required.

The use of dispensing devices is known in the prior art. More specifically, dispensing devices heretofore devised and utilized for the purpose of dispensing items for consumer use are known to consist basically of familiar, expected and obvious structural configurations, notwithstanding the myriad of designs encompassed by the crowded prior art which have been developed for the fulfillment of countless objectives and requirements.

While these devices fulfill their respective, particular objective and requirements, these patents do not describe a sugar dispensing system for allowing pre-measured amounts of sugar to be accurately dispensed into an awaiting vessel.

In this respect, the sugar dispensing system according to the present invention substantially departs from the conventional concepts and designs of the prior art, and in doing so provides an apparatus primarily developed for the purpose of allowing pre-measured amounts of sugar to be accurately dispensed into an awaiting vessel.

Therefore, it can be appreciated that there exists a continuing need for a new and improved sugar dispensing system which can be used for allowing pre-measured amounts of sugar to be accurately dispensed into an awaiting vessel. In this regard, the present invention substantially fulfills this need.

### SUMMARY OF THE INVENTION

In the view of the foregoing disadvantages inherent in the known types of dispensing devices now present in the prior art, the present invention provides an improved sugar dispensing system. As such, the general purpose of the present invention, which will be described subsequently in greater detail, is to provide a new and improved sugar dispensing system, which has all the advantages of the prior art and none of the disadvantages.

To attain this, the present invention essentially comprises a housing having a generally rectangular configuration. The housing has a top wall, a bottom wall, a front wall, a rear wall, and opposed sidewalls. The top wall has an opening therein exposing a general storage chamber. The general storage chamber has a closed bottom wall. The closed bottom wall has a plurality of openings disposed therein. The front wall has a recess formed therein upwardly of the bottom wall. A plurality of storage vials are disposed within the housing. The storage vials each have open upper and lower ends. The open upper ends are aligned with the plurality of openings in the closed bottom wall of the general storage chamber. The open lower ends are exposed above the recess in the front wall of the housing. The storage vials include viewing windows disposed within the front wall of the housing. The storage vials include dispensing mechanisms at the open lower ends thereof. A plurality of refill rods extend inwardly of the front wall of the housing above the open upper ends of the plurality of storage vials. Each of the refill rods has an outer handle portion and a plurality of measuring holes therein. The measuring holes correspond with specific measurement amounts.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved sugar dispensing system, which has all the advantages of the prior art dispensing devices and none of the disadvantages.

It is another object of the present invention to provide a new and improved sugar dispensing system, which may be easily and efficiently manufactured and marketed.

It is a further object of the present invention to provide a new and improved sugar dispensing system, which is of durable and reliable construction.

An even further object of the present invention is to provide a new and improved sugar dispensing system which is susceptible of a low cost of manufacture with regard to both materials and labor, and which accordingly is then susceptible of low prices of sale to the consuming public, thereby making such sugar dispensing system economically available to the buying public.

Even still another object of the present invention is to provide a new and improved sugar dispensing system for allowing pre-measured amounts of sugar to be accurately dispensed into an awaiting vessel.

Lastly, it is an object of the present invention to provide a new and improved sugar dispensing system including a housing having a top wall, a bottom wall, a front wall, a rear wall, and opposed sidewalls. The top wall has an opening therein exposing a general storage chamber. The general storage chamber has a closed bottom wall. The closed bottom wall has a plurality of openings disposed therein. The front wall has a recess formed therein upwardly of the bottom wall. A plurality of storage vials are disposed within the housing. The storage vials each have open upper and lower ends. The open upper ends are aligned with the plurality of openings in the closed bottom wall of the general storage chamber. The open lower ends are exposed above the recess in the front wall of the housing. The storage vials include dispensing mechanisms at the open lower ends thereof.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the sugar dispensing system constructed in accordance with the principles of the present invention.

FIG. 2 is a front view of the present invention.

FIG. 3 is a top plan view of one of the refill rods of the present invention.

The same reference numerals refer to the same parts through the various figures.

### DESCRIPTION OF THE PREFERRED EMBODIMENT

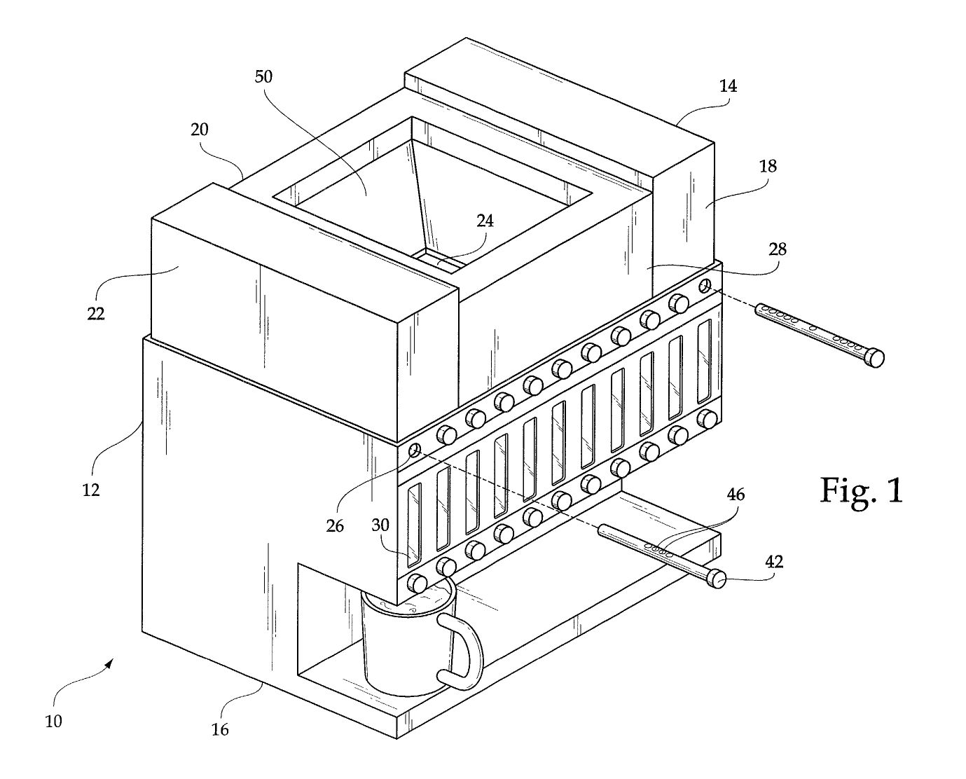

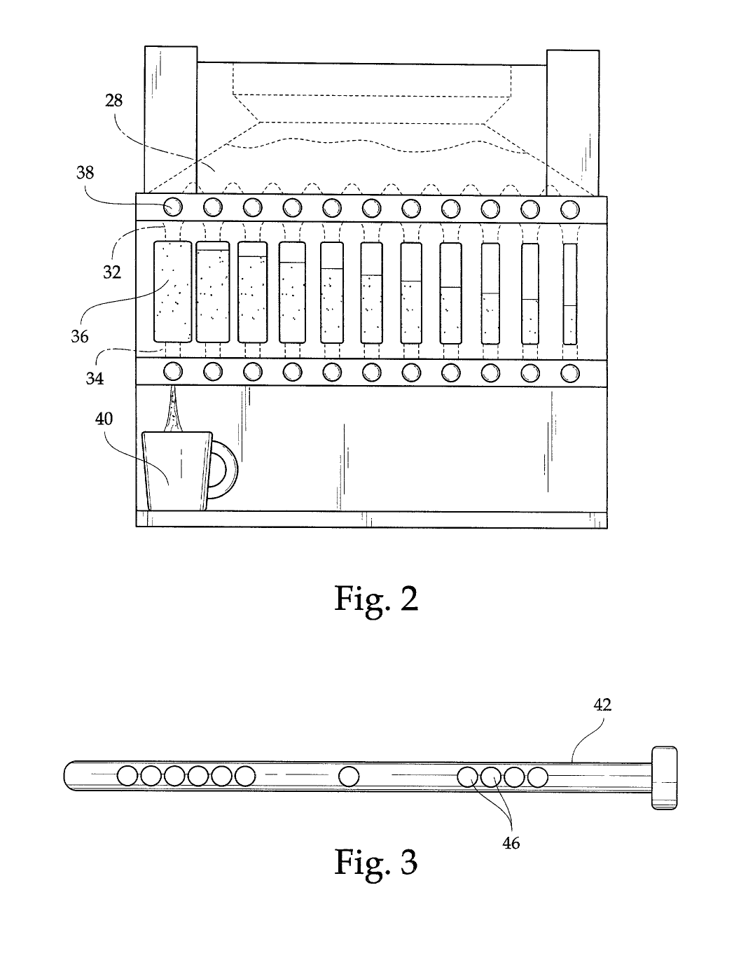

With reference now to the drawings, and in particular, to FIGS. 1 through 3 thereof, the preferred embodiment of the new and improved sugar dispensing system embodying the principles and concepts of the present invention and generally designated by the reference number 10 will be described.

Specifically, it will be noted in the various Figures that the device relates to a sugar dispensing system for allowing pre-measured amounts of sugar to be accurately dispensed into an awaiting vessel. In its broadest context, the device consists of a housing, a plurality of storage vials, and a plurality of refill rods. Such components are individually configured and correlated with respect to each other so as to attain the desired objective.

The housing 12 has a generally rectangular configuration. The housing 12 has a top wall 14, a bottom wall 16, a front wall 18, a rear wall 20, and opposed sidewalls 22. The rear wall 20 can be provided with means to allow for securement of the housing 12 to a kitchen wall or other area. The top wall 14 has an opening 50 therein exposing a general storage chamber 24. The general storage chamber 24 has a closed bottom wall. The closed bottom wall has a plurality of openings 26 disposed therein. The front wall 18 has a recess 28 formed therein upwardly of the bottom wall 16. The general storage chamber 24 will hold a bulk quantity of sugar or other spice. The opening 50 allows for the bulk quantity to be added to the general storage chamber 24. Additionally, a lid can be provided for covering the opening 50 when not in use. Furthermore, a folding funnel arrangement can be provided that will allow the bulk quantity of sugar or other spice to be easily poured into the general storage chamber 24.

The plurality of storage vials 30 are disposed within the housing 12. The storage vials 30 each have open upper and lower ends 32,34. The open upper ends 32 are aligned with the plurality of openings 26 in the closed bottom wall of the general storage chamber 24. The open lower ends 34 are exposed above the recess 28 in the front wall 18 of the housing 12. The storage vials 30 include viewing windows 36 disposed within the front wall 18 of the housing 12. The storage vials 30 include dispensing mechanisms 38 at the open lower ends thereof. The dispensing mechanisms 38 can be chose from buttons, levers, and switches to allow for the contents of the storage vials 30 to be dispensed into an awaiting vessel 40 that is position within the recess 28 below the open lower end 34.

The plurality of refill rods 42 extend inwardly of the front wall 18 of the housing 12 above the open upper ends 32 of the plurality of storage vials 30. Each of the refill rods 42 has an outer handle portion 44 and a plurality of measuring holes 46 therein. The measuring holes 46 correspond with specific measurement amounts. The measurement holes 46 allow a user to rotate the refill rods 42 a single revolution whereby a correct amount of sugar or other spice will fall from the general storage chamber 24 into the corresponding storage vial 30 whereupon this amount can then be dispensed into the awaiting vessel 40.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A sugar dispensing system for allowing pre-measured amounts of sugar to be accurately dispensed into an awaiting vessel, the system comprising, in combination:
a housing having a generally rectangular configuration, the housing having a top wall, a bottom wall, a front wall, a rear wall, and opposed side walls, the top wall having an opening therein exposing a general storage chamber, the general storage chamber having a closed bottom wall, the closed bottom wall having a plurality of openings disposed therein, the front wall having a recess formed therein upwardly of the bottom wall;
a plurality of storage vials disposed within the housing, the storage vials each having open upper and lower ends, the open upper ends being aligned with the plurality of openings in the closed bottom wall of the general storage chamber, the open lower ends being exposed above the recess in the front wall of the housing, the storage vials including viewing windows disposed within the front wall of the housing, the storage vials including dispensing mechanisms at the open lower ends thereof; and
a plurality of refill rods extending inwardly of the front wall of the housing above the open upper ends of the plurality of storage vials, each of the refill rods having an outer handle portion and a plurality of measuring holes therein, the measuring holes corresponding with specific measurement amounts.

2. A sugar dispensing system for allowing pre-measured amounts of sugar to be accurately dispensed into an awaiting vessel, the system comprising, in combination:
a housing having a top wall, a bottom wall, a front wall, a rear wall, and opposed side walls, the top wall having an opening therein exposing a general storage chamber, the general storage chamber having a closed bottom wall, the closed bottom wall having a plurality of openings disposed therein, the front wall having a recess formed therein upwardly of the bottom wall; and
a plurality of storage vials disposed within the housing, the storage vials each having open upper and lower ends, the open upper ends being aligned with the plurality of openings in the closed bottom wall of the general storage chamber, the open lower ends being exposed above the recess in the front wall of the housing, the storage vials including dispensing mechanisms at the open lower ends thereof.

3. The sugar dispensing system as set forth in claim 2, wherein the storage vials include viewing windows disposed within the front wall of the housing.

4. The sugar dispensing system as set forth in claim 2, and further including a plurality of refill rods extending inwardly of the front wall of the housing above the open upper ends of the plurality of storage vials, each of the refill rods having an outer handle portion and a plurality of measuring holes therein, the measuring holes corresponding with specific measurement amounts.
